(19) United States
(12) Patent Application Publication
(10) Pub. No.: US 2026/0052207 A1
(43) Pub. Date: Feb. 19, 2026

(54) METHOD AND APPARATUS FOR INTERFACE INTERACTION, DEVICE AND STORAGE MEDIUM

(71) Applicants: Beijing Zitiao Network Technology Co., Ltd., Beijing (CN); LEMON INC., Grand Cayman (KY)

(72) Inventors: Jiahui Yang, Beijing (CN); Jiayi Xu, Beijing (CN); Wei Xu, Los Angeles, CA (US)

(21) Appl. No.: 19/302,740

(22) Filed: Aug. 18, 2025

(30) Foreign Application Priority Data
Aug. 19, 2024 (WO) PCT/CN2024/113215

(51) Int. Cl. H04M 1/72436; H04M 1/72427; H04M 1/72469

(52) U.S. Cl. CPC H04M 1/72436; H04M 1/72427; H04M 1/72469; H04M 2201/42

(57) ABSTRACT

A method for interface interaction and an apparatus, a device, and a storage medium are provided. The method provided by the disclosure includes: presenting an interactive component in a target interface, wherein the interactive component displays first content associated with a target user; and in response to a sliding operation of a current user for the interactive component, sending a predetermined message corresponding to a sliding direction to the target user in a session of the current user and the target user based on the sliding direction of the sliding operation, the predetermined message indicating the target feedback of the target user for the first content. In this manner, the embodiments of the present disclosure can improve the information interaction efficiency.

### CROSS REFERENCE

The present application claims priority to PCT Application PCT/CN2024/113215, filed on Aug. 19, 2024, and entitled “METHOD AND APPARATUS FOR INTERFACE INTERACTION, DEVICE AND STORAGE MEDIUM”, the entirety of which is incorporated herein by reference.

### FIELD

Example embodiments of the present disclosure generally relate to the field of computers, and in particular, to an interface interaction method, apparatus, device, and computer-readable storage medium.

### BACKGROUND

In recent years, with the development of the Internet, more and more users perform network activities on a plurality of network platforms. For example, a user sends or views an interactive message on a network platform. However, manners of the interaction provided by the existing network platform for the interaction message cannot meet the interaction requirement of the user.

### SUMMARY

In a first aspect of the present disclosure a method for interface interaction is provided, including: presenting an interactive component in a target interface, the interactive component displaying first content associated with a target user; and in response to a sliding operation of a current user with respect to the interactive component, sending a predetermined message corresponding to a sliding direction to the target user in a session between the current user and the target user based on the sliding direction of the sliding operation, the predetermined message indicating target feedback of the target user for the first content.

In a second aspect of the present disclosure, an apparatus for interface interaction is provided. The apparatus includes a presentation module, configured to present an interactive component in a target interface, the interactive component displaying first content associated with a target user; and a sending module, configured to, in response to a sliding operation of a current user with respective to the interactive component, send a predetermined message corresponding to a sliding direction to the target user in a session between the current user and the target user based on the sliding direction of the sliding operation, the predetermined message indicating target feedback of the target user for the first content.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that what is described in this Summary section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments of the present disclosure may be implemented;

FIGS. 2A-2D illustrate example interfaces according to some embodiments of the present disclosure;

FIGS. 3A-3F illustrate example interfaces according to further embodiments of the present disclosure;

FIG. 4 shows a flowchart of an example process of interface interaction according to some embodiments of the present disclosure;

FIG. 5 illustrates a schematic structural block diagram of an example apparatus for interface interaction according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the headings of any section/subsection provided herein is not limiting. Various embodiments are described herein, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the term “including” and the like should be understood as open-ended including, that is “including but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow respective laws and regulations and related regulations. In embodiments of the present disclosure, all data collection, acquisition, processing, processing, forwarding, use, and the like, are made with user knowledge and confirmation. Accordingly, when implementing embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

In the present description and the embodiments, solutions, if personal information processing is involved, are performed on the basis of legitimacy (e.g., the consent of the personal information body is obtained, or necessary for fulfillment of a contract, etc.), and is performed only within a specified range or an agreed range. The user rejects personal information other than the necessary information required for processing the basic function, and the use of the basic function by the user is not affected.

As briefly mentioned above, with the development of the Internet, more and more users perform network activities on multiple network platforms. For example, a user sends or views an interactive message on a network platform. However, the manners of the interaction provided by existing network platforms for the interaction message cannot meet the interaction requirement of the user.

Embodiments of the present disclosure provide a solution for interface interaction. According to the solution, an interactive component may be presented in a target interface, and the interactive component displays first content associated with a target user; and in response to a sliding operation of a current user for the interactive component, a predetermined message corresponding to a sliding direction is sent to the target user in a session between the current user and the target user based on the sliding direction of the sliding operation, and the predetermined message indicates target feedback of the target user for the first content.

In this manner, embodiments of the present disclosure may provide an interactive component that may display content to the user in the target interface. In addition, embodiments of the disclosure may determine the predetermined message corresponding to the sliding direction based on the sliding direction of the sliding operation of the user on the interactive component and send the predetermined message to the session between the current user and the target user. Therefore, according to embodiments of the disclosure, the user may quickly reply to the message to the sender of the content through the sliding operation, so that the information interaction efficiency is improved.

Various example implementations of this scheme are described in detail below in conjunction with the accompanying drawings.

### Example Environment

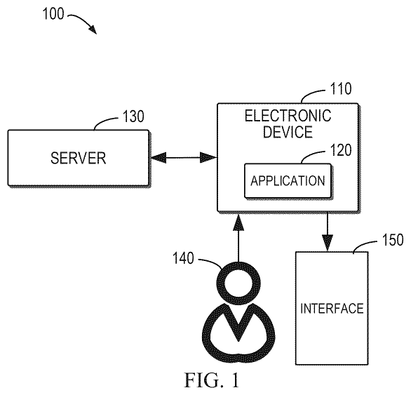

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. Application 120 may be any type of suitable application for interface interaction, examples of which may include, but are not limited to: a video application, a social application, or other suitable applications. The user 140 may interact with the application 120 via the electronic device 110 and/or its attached device.

In the environment 100 of FIG. 1, if the application 120 is active, the electronic device 110 may present an interface 150 for supporting interface interaction via the application 120.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for the user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In embodiments of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Message Interactions

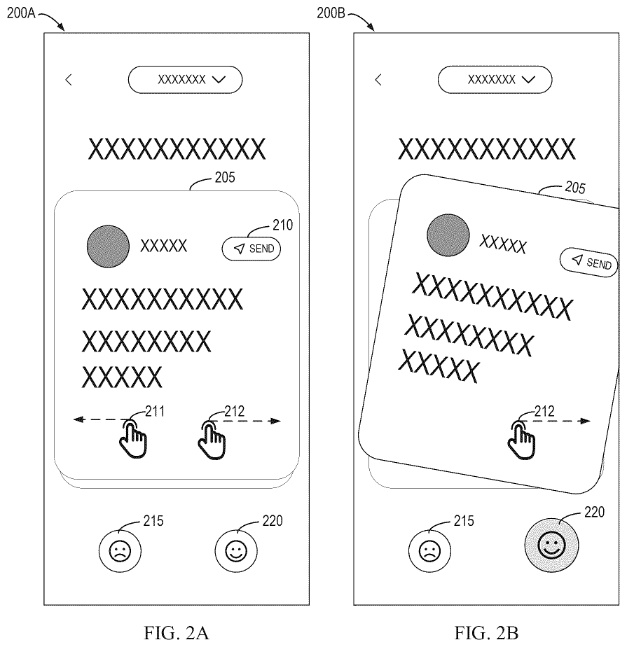

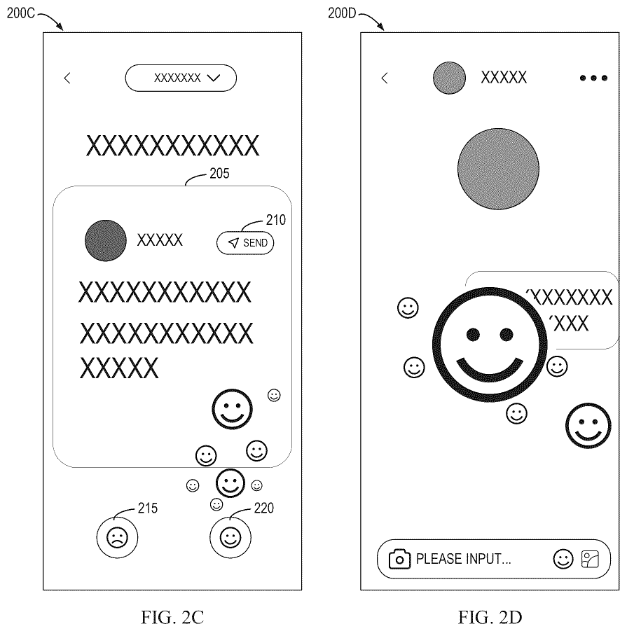

FIGS. 2A-2D illustrate example interfaces 200A-200D, according to some embodiments of the present disclosure. The interface 200A to the interface 200D may be provided, for example, by the electronic device 110 shown in FIG. 1.

In some embodiments, as shown in FIG. 2A, the electronic device 110 may present an interactive component 205 in a target interface 200A. The interactive component 205 may display content received by a current user. As an example, a type of content received by the current user may include text content, image content, voice content, and the like.

In some embodiments, with continued reference to FIG. 2A, the target interface 200A may be a viewing interface of an information stream. The electronic device 110 may switch the target interface 200A to presenting media content in an information stream in response to a predetermined operation received in the target interface 200A.

In some cases, the information stream is also referred to as a Feed stream, which may be associated with a plurality of pieces of media content (e.g., a plurality of works), and support the current user to switch to a playing of other media content in the information stream in response to a predetermined operation (e.g., sliding up and down) of the target interface 200A. As an example, the electronic device 110 may switch the target interface 200A from the presentation of the interactive component 205 to the presentation of the media content in the information stream in response to receiving a predetermined operation (e.g., sliding up-and-down or a click operation) of the current user at the target interface 200A.

In some embodiments, the information stream may be associated with a variety of media content types. As an example, the media content type may include, but is not limited to, video content, text content, music content, and the like.

In some embodiments, with continued reference to FIG. 2A, the electronic device 110 may display the first content associated with the target user in the interactive component 205. As an example, the first content may be, for example, content sent by the target user to the current user.

In some embodiments, with continued reference to FIG. 2A, the first content may indicate a selection of a target interaction item associated with the current user by the target user.

In some embodiments, the process of generating the first content may include: the client associated with the target user generates an interactive message associated with the target interactive item based on the target user's selection of the target interactive item associated with the current user. The electronic device 110 may receive the interaction message associated with the target interaction item sent by the client associated with the target user. Further, the electronic device 110 may present, in the interactive component 205, the interaction content determined based on the interaction message associated with the target interaction item.

As an example, the client associated with the target user may determine the target interaction item selected by the target user based on the interaction operation of the target user. As an example, the client associated with the target user may determine the target interaction item selected by the target user based on a voting operation of the target user on the voting component (e.g., a selection of at least one of a plurality of voting options). As an example, a voting component may include descriptive content (e.g., who you consider is the most XXX?). The plurality of voting options may include a plurality of options (e.g., user A, user B, user C, user D, etc.). The target interaction item may include, for example, a user C associated with the current user.

In some embodiments, with continued reference to FIG. 2A, the electronic device 110 may send a predetermined message corresponding to a sliding direction to the target user in a session between the current user and the target user based on the sliding direction of a sliding operation in response to receiving the sliding operation of the current user for the interactive component 205.

In some embodiments, the predetermined message may indicate target feedback of the target user for the first content. As an example, the target feedback for the first content may include, for example, an approval, an objection, no evaluation, and the like. As an example, when the target feedback is an approval, the predetermined message associated with the target feedback may be, for example, “I strongly agrees” or “I endorse”.

As an example, with continued reference to FIG. 2A, the electronic device 110 may receive a sliding operation 212 of the current user. In some embodiments, such a sliding operation 212 may indicate a target direction. For example, the sliding operation 212 may include a sliding operation in the target direction, for example, a right-sliding operation. As an example, the electronic device 110 may send a predetermined message (e.g., happy) corresponding to the sliding operation 212 to a session between the current user and the target user.

As an example, with continued reference to FIG. 2A, the electronic device 110 may receive a sliding operation 211 of the current user. In some embodiments, such sliding operation 211 may indicate a target direction. For example, the sliding operation 211 may include a sliding operation in a target direction, for example, a left-sliding operation. As an example, the electronic device 110 may send a predetermined message (e.g., sadness) corresponding to the operation 211 to the session between the current user and the target user.

In some embodiments, with continued reference to FIG. 2A, the electronic device 110 may present a plurality of indication elements in the target interface 200A. The plurality of indication elements may correspond to a plurality pieces of predetermined feedback for the first content.

As an example, the electronic device 110 may determine the message content based on a predetermined piece of feedback. As an example, the plurality of indication elements may include a first indication element 215 and a second indication element 220. As an example, the first indication element 215 may indicate a first piece of feedback of the plurality pieces of predetermined feedback. The second indication element 220 may indicate a second piece of feedback of the plurality of predetermined feedback.

In some embodiments, the first indication element 215 may be associated with the sliding operation 211 in a first direction. Further, the electronic device 110 may send the message content determined based on the first feedback to the session between the current user and the target user in response to receiving the sliding operation 211.

In some embodiments, the second indication element 220 may be associated with the sliding operation 212 in a second direction. Further, the electronic device 110 may send the message content determined based on the second feedback to the session between the current user and the target user in response to receiving the sliding operation 212.

In some embodiments, as shown in FIG. 2B, the electronic device 110 may adjust the display style of the target indication element of the plurality of indication elements in the target interface 200B in response to the sliding operation of the current user for the interactive component 205, to indicate the target feedback corresponding to the sliding operation.

As an example, with continued reference to FIG. 2B, the electronic device 110 may adjust the display style of the second indication element 220 (e.g., adjust the background color and/or size of the second indication element 220) in the target interface 200B in response to receiving the sliding operation 212 for the target component 205 to indicate that the sliding operation 212 corresponds to the second feedback associated with the second indication element 220.

In some embodiments, with continued reference to FIG. 2B, the electronic device 110 may, in response to receiving the sliding operation 212, cause the presentation interactive component 205 to switch to an animation process that presents second content (e.g., rotate and/or move the interactive component 205, etc.) until the interactive component 205 fully presents the second content.

In some embodiments, as shown in FIG. 2C, the electronic device 110 may present, in the target interface 200C, a first animation associated with the target indication element of the plurality of indication elements in response to receiving the sliding operation of the current user for the interactive component 205. The target indication element corresponds to the target feedback.

As an example, with continued reference to FIG. 2C, the electronic device 110 may present, in response to receiving the sliding operation 212 of the current user for the target component 205, a first animation associated with the second indication element 220 in the target interface 200B (e.g., a process in which the plurality of smiling images with different sizes emerge from the second indication element 225 and gradually disappear).

In some embodiments, the electronic device 110 may trigger, in response to receiving the sliding operation of the current user for the interactive component 205, the client associated with the target user: based on the received predetermined message, to present, in the session interface 200D presented by the client associated with the target user, a second animation associated with the target indication element.

As an example, as shown in FIG. 2D, the electronic device 110 may present, in response to receiving the sliding operation 212 for the target component 205, a predetermined message in the session interface 200D of the current user and the target user and/or a second animation associated with the second indication element 220 (e.g., a process of surfacing and gradually disappearing a plurality of smiley face images of different sizes).

In some embodiments, with continued reference to FIG. 2C, the interactive component 205 may be associated with a set of content that includes the first content. In some embodiments, the set of content may include content from multiple users received by the current user.

In some embodiments, the sliding operation may be a first sliding operation, and the sliding direction is a first sliding direction (e.g., parallel to a sliding direction of the sliding operation 212). The electronic device 110 may switch the presentation component to presenting second content in the set of content in response to a completion of the first sliding operation.

In some embodiments, the electronic device 110 may switch the presentation component 205 to presenting third content in the set of content in response to receiving a second sliding operation for the interactive component 205. As an example, the third content may be different from the second content. The second sliding direction corresponding to the second sliding operation may be perpendicular to the first sliding direction. As an example, the electronic device 110 may, for example, further switch the presentation component 205 to presenting a new set of content different from the foregoing set of content in response to receiving the second sliding operation for the interactive component.

In some embodiments, with continued reference to FIG. 2A, the electronic device 110 may present the interactive component 205 in a target style in the viewing interface 200A. The target style may be determined based on a number of items of content to be presented in the content set.

In some embodiments, with continued reference to FIG. 2A, the electronic device 110 may present, in response to the number of items of the content to be presented being greater than the target threshold, a plurality of component elements in the interactive component 210 in the stack. As an example, if the set of content further includes one or more items of the content that shows the order behind the first item of the content, the electronic device 110 may present a stacking style to indicate that the set of content further includes one or more items of the content to be presented.

In some embodiments, the target style may also indicate a number of one or more items of the content to be presented. For example, the set of content may include a plurality of items of to-be-displayed content, that is, a quantity of items of to-be-displayed content is greater than one. Accordingly, the electronic device 110 may display a stack of multiple component elements. Taking FIG. 2A as an example, the electronic device 110 may display a stack of two component elements to indicate that the first set of content includes two items of content to be presented.

In some embodiments, the number of component elements displayed in the stack in the electronic device 110 may be the same as or different from the number of items of the content to be presented. For example, when the set of content includes more than a predetermined number (e.g., three) of items of the content to be presented, the electronic device 110 may, for example, always display a stack of three component elements to reduce the complexity of the interactive component 205.

In some embodiments, with continued reference to FIG. 2A, the electronic device 110 may provide a message portal 210 in the interactive component 205. Further, the electronic device 110 may send a message (e.g., a text message, a voice message, an image message, etc.) obtained via the message portal 215 to the target user in the session between the current user and the target user.

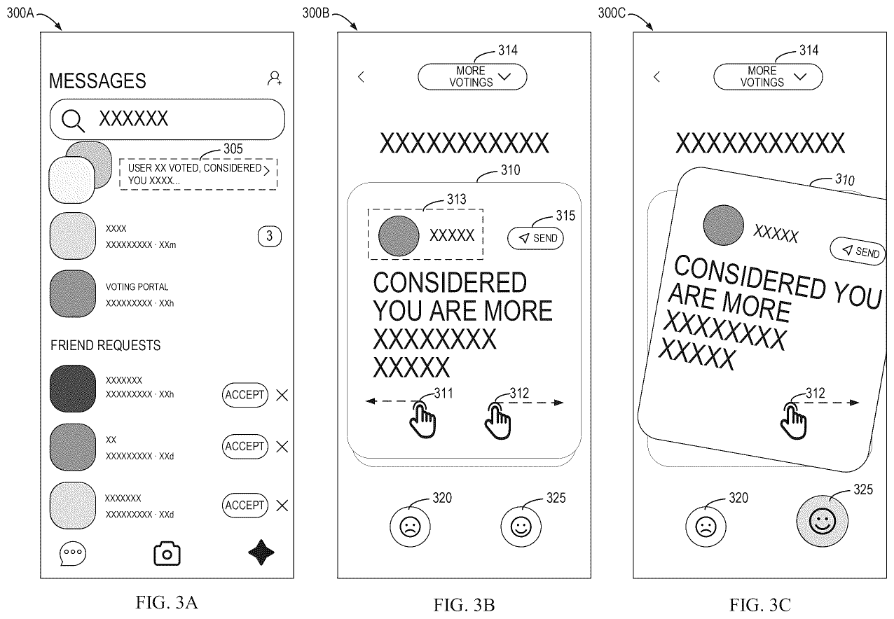

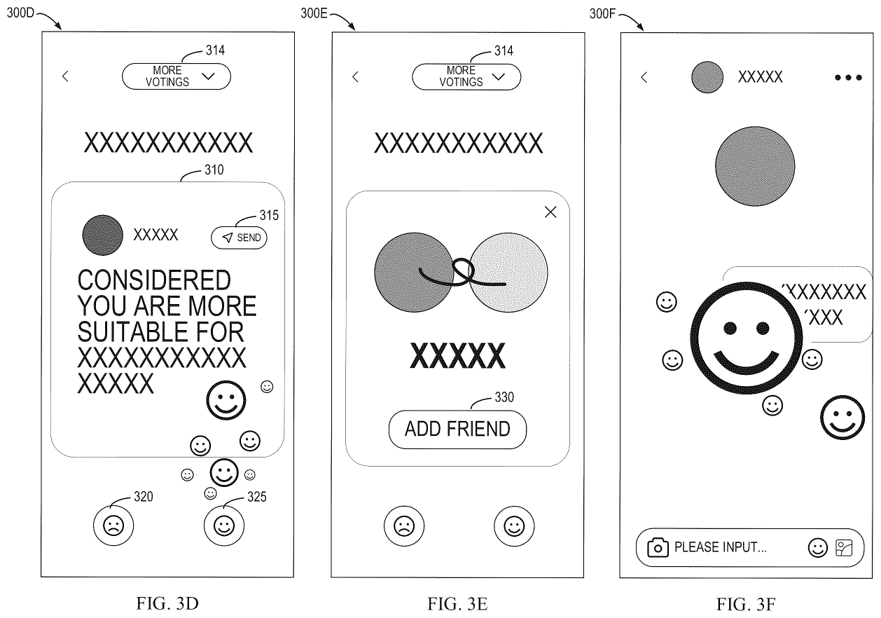

The above message interaction process is described as an example below based on FIGS. 3A to 3F.

FIGS. 3A-3F illustrate example interfaces 300A-300F, according to some embodiments of the present disclosure. The interface 300A to the interface 300F may be provided, for example, by the electronic device 110 shown in FIG. 1.

In some embodiments, as shown in FIG. 3A, electronic device 110 may present the message interface 300A. As an example, the electronic device 110 may present message content received by the current user (e.g., received messages from other users or friend requests of other users, etc.) in the message interface 300A.

In some embodiments, with continued reference to FIG. 3A, the electronic device 110 may receive an interaction message for the current user. The electronic device 110 may present an interactive message portal 305 in the message interface 300A. As an example, the interactive message portal 305 may present at least one interactive message received by the current user. As an example, the at least one interactive message may include an interactive message generated based on an interactive operation of a plurality of users. As an example, the at least one interactive message may include an interactive message from a target user.

In some embodiments, the process of generating the interactive message from the target user may include: the client associated with the target user generates an interactive message associated with a target interactive item based on the target user's selection of the target interactive item associated with the current user. Further, the electronic device 110 may receive an interaction message associated with the target interaction item sent by the client associated with the target customer.

As an example, the client associated with the target user may determine the target interaction item selected by the target user based on an interaction operation of the target user. As an example, the client associated with the target user may determine the target interaction item selected by the target user based on a voting operation of the target user on a voting component (e.g., a selection of at least one of a plurality of voting options). As an example, the voting component may include descriptive content (e.g., who you consider is the most XXX?). The plurality of voting options may include a plurality of options (e.g., user A, user B, user C, user D, etc.). The target interaction item may include, for example, a user C associated with the current user.

As an example, the electronic device 110 may present in message interface 300A image content associated with at least one interactive message (e.g., a partial user avatar associated with the at least one interactive message).

In some embodiments, as shown in FIG. 3B, the electronic device 100 may present the interactive component 310 in a viewing interface 300B. As an example, the foregoing target interface may include the viewing interface presented herein and hereinafter, and the viewing interface is only one of a plurality of interfaces included in the target interface.

In some embodiments, with continued reference to FIG. 3B, the electronic device 110 may present the interactive component 310 in the viewing interface 300B based on a selection of a target interaction item associated with the current user by the target user.

As an example, the client associated with the target user may trigger the electronic device 110 to present the interactive component 310 in the viewing interface 300B in response to receiving the selection of the target interaction item associated with the current user by the target user.

In some embodiments, the electronic device 110 may present the viewing interface 300B associated with the current user in response to receiving a first predetermined operation of the current user on the interactive message. As an example, as shown in FIG. 3A, the electronic device 110 may present the viewing interface 300B associated with the current user in response to receiving a trigger (e.g., a click operation) of the current user on the interaction message portal 305.

In some embodiments, the viewing interface 300B may be the viewing interface 300B of the information stream associated with the current user.

In some embodiments, with continued reference to FIG. 3B, the electronic device 110 may switch the viewing interface 300B to presenting media content an information stream in response to a fifth predetermined operation (e.g., a sliding operation) received in the viewing interface 300B.

In some cases, the information stream is also referred to as a Feed stream, which may be associated with a plurality of pieces of media content (e.g., a plurality of works) and support the current user to switch to a playing of other media content in the information stream in response to a predetermined operation (e.g., sliding up and down) of the viewing interface 300B. As an example, the electronic device 110 may switch the viewing interface 300B from the presentation of the interactive component 310 to the presentation of the media content in the information stream in response to receiving a predetermined operation (e.g., sliding up-down or a click operation, etc.) of the current user at the viewing interface 300B.

In some embodiments, the information stream may be associated with a variety of media content types. As an example, the media content type may include, but is not limited to, video content, text content, music content, and the like.

In some embodiments, with continued reference to FIG. 3B, the electronic device 110 presents identification information 313 (e.g., user avatar and/or username, etc.) of the target user in the interactive component 310. In some embodiments, the electronic device 110 may further present, in the interactive component 310, first content generated based on the target interaction item. As an example, the target interaction item may indicate description information for the current user (e.g., the friend that best conforms to the description XXXX is XXXXX). The first content generated based on the target interaction item may include, for example, message content generated based on the description information of the current user (e.g., XXX considers that you are more likely to be XXXX).

In some embodiments, the interactive component 310 may be associated with a first set of content. As an example, the first set of content may include a plurality of items of first content associated with a predetermined condition. The predetermined condition may include, for example, a predetermined theme (e.g., a music theme, a life theme, and the like).

In some embodiments, with continued reference to FIG. 3B, the electronic device 110 may present the interactive component 310 in a target style in the viewing interface 300B. The target style may be determined based on a number of items of content to be presented in the first set of content.

In some embodiments, with continued reference to FIG. 3B, the electronic device 110 may present, in response to the number of items of the content to be presented being greater than the target threshold, a plurality of component elements in the interactive component 310 in the stack. As an example, if the first set of content further includes one or more items of content that are sequentially after the first item of content, the electronic device 110 may present a stacking style to indicate that the first set of content further includes one or more items of the content to be presented.

In some embodiments, the target style may also indicate a number of one or more items of the content to be presented. For example, the first set of content may include a plurality of items of content to-be-displayed, that is, a quantity of items of the content to-be-displayed is greater than one. Accordingly, the electronic device 110 may display a stack of multiple component elements. Taking FIG. 3B as an example, the electronic device 110 may display a stack of two component elements to indicate that the first set of content includes two items of content to be presented.

In some embodiments, the number of component elements displayed in the stack in the electronic device 110 may be the same as or different from the number of items of the content to be presented. For example, when the first set of content includes more than a predetermined number (e.g., three) of items of the content to be presented, the electronic device 110 may, for example, always display a stack of three component elements to reduce the complexity of the interactive component 310.

In some embodiments, with continued reference to FIG. 3B, the electronic device 110 may switch the interactive component 310 to second content in the first set of content in response to a second predetermined operation for the interactive component 310. As an example, the second predetermined operation may include a sliding operation. The electronic device 110 may switch the interactive component 310 to the second content in the first set of content in response to a sliding operation on the interactive component 310. As an example, the second content may be determined based on a sliding direction of the sliding operation.

In some embodiments, as shown in FIG. 3C, the electronic device 110 may, in response to receiving a sliding operation 312, cause the presentation interactive component 310 to switch to an animation process that presents the second content (e.g., rotate and/or move the interactive component 310, etc.) until the interactive component 310 fully presents the second content.

In some embodiments, with continued reference to FIG. 3B, the electronic device 110 may send a message determined based on a third predetermined operation to the target user in the session between the current user and the target user in response to receiving the third predetermined operation in the viewing interface.

In some embodiments, the third predetermined operation may include a sliding operation on the interactive component.

As an example, with continued reference to FIG. 3B, the electronic device 110 may receive the sliding operation 312 of the current user. In some embodiments, such sliding operation 312 may indicate a target direction. For example, the sliding operation 312 may include a sliding operation in a target direction, for example, a right-sliding operation. As an example, the electronic device 110 may send a message (e.g., happy) corresponding to the sliding operation 312 to the current user's session with the target user.

As an example, with continued reference to FIG. 3B, the electronic device 110 may receive a sliding operation 311 of the current user. In some embodiments, such sliding operation 311 may indicate a target direction. For example, the sliding operation 311 may include a sliding operation in a target direction, for example, a left-sliding operation. As an example, the electronic device 110 may send a message (e.g., sadness) corresponding to the operation 311 to the session between the current user and the target user.

In some embodiments, with continued reference to FIG. 3B, the third predetermined operation may include: for the selection of the indication element in the viewing interface 300B, the indication element corresponding to the predetermined feedback for the first content.

In some embodiments, with continued reference to FIG. 3B, the electronic device 110 may provide a plurality of indication elements in the viewing interface. As an example, the plurality of indication elements may correspond to a plurality of pieces of predetermined feedback. As an example, the predetermined feedback may indicate feedback of the current user to the first content. The electronic device 110 may generate the message content based on the predetermined feedback. As an example, the plurality of indication elements may include a first indication element 320 and a second indication element 325. As an example, the first indication element 320 may indicate a first piece of feedback of a plurality of pieces of predetermined feedback. The second indication element 325 may indicate a second piece of feedback of the plurality of pieces of predetermined feedback.

In some embodiments, the first indication element 320 may be associated with the sliding operation 311 in a first direction. Further, the electronic device 110 may send the message content generated based on the first feedback to the session between the current user and the target user in response to receiving the sliding operation 311.

In some embodiments, the second indication element 325 may be associated with the sliding operation 312 in a second direction. Further, the electronic device 110 may send the message content generated based on the second feedback to the session between the current user and the target user in response to receiving the sliding operation 312.

In some embodiments, as shown in FIG. 3C, the electronic device 110 may display the second indication element 325 differently in the viewing interface 300C (e.g., adjust the background color and/or size of the second indication element 325) in response to receiving the sliding operation 312 in the viewing interface 300C.

In some embodiments, as shown in FIG. 3D, the electronic device 110 may present, in the viewing interface 300D, an animation effect associated with the second indication element (e.g., a process in which the plurality of different smiley face images emerges from the second indication element 325 and gradually disappear).

In some embodiments, the electronic device 110 may further send the message content generated based on the first feedback or the second feedback to the session between the current user and the target user in response to receiving a selection (e.g., a click operation) of the first indication element 320 or the second indication element 325 by the current user.

In some embodiments, with continued reference to FIG. 3B, the third predetermined operation may include a selection of a message portal in the viewing interface 300B. As an example, the electronic device 110 may provide a message portal 315 in the viewing interface 300B. Further, the electronic device 110 may send a message (e.g., a text message, a voice message, an image message, etc.) obtained via the message portal 315 to the session between the current user and the target user.

In some embodiments, with continued reference to FIG. 3D, the interactive component 310 is a first interactive component. The electronic device 110 may provide a filtering control 314 in the viewing interface 300D. The electronic device 110 may present a second interactive component in the viewing interface 300D based on a target condition determined via the filtering control 314. The second interactive component is associated with a second set of content that matches the target condition.

As an example, the electronic device 110 may present a plurality of predetermined conditions in response to a trigger on the filtering control 314. The plurality of predetermined conditions may include, for example, a plurality of predetermined topics (e.g., a music topic, a life topic, etc.), a plurality of friend relationships (e.g., a close friend, a stranger, etc.). Further, the electronic device 110 may present, based on a selection of the target condition of the plurality of predetermined conditions by the current user, the second interactive component associated with the target condition.

In some embodiments, as shown in FIG. 3E, the electronic device 110 may provide an adding portal 330 in the interactive component 310 in response to receiving the fourth predetermined operation in the viewing interface 300E. The adding portal 330 is used to trigger an adjustment of the interaction relationship between the current user and the target user. As an example, the interaction relationship may include a friend relationship.

As an example, with continued reference to FIG. 3E, the electronic device 110 may present the adding portal 330 in the interactive component 310 in response to receiving a request for the current user to send a message to the target user (e.g., the third predetermined operation aforementioned). As an example, the electronic device 110 may present the adding portal 330 in the interactive component 310 in response to receiving a request for the current user to send a message to the target user, and the current user and the target user do not satisfy an interaction relationship. Further, the electronic device 110 may send a request for establishing an interactive relationship (e.g., adding a friend) to the target user in response to receiving a trigger (e.g., a click operation) of the current user for the adding portal 330.

In some embodiments, with continued reference to FIG. 3D, the electronic device 110 may present a selection control (not shown) in the viewing interface 300D in response to the current user's request. Further, the electronic device 110 may receive, via the selection control, a selection of the second user by the current user. As an example, the electronic device 110 may present a plurality of user options (e.g., a plurality of user options associated with the current user) in response to a trigger (e.g., a click operation) of the selection control by the current user. Further, the electronic device 110 may receive a selection of a target user option of the plurality of user options by the current user and determine the second user.

In some embodiments, the electronic device 110 may receive a selection of the second user by the current user. Further, the electronic device 110 may, in response to a predetermined condition associated with the second user being satisfied, trigger the client associated with the second user to present at least one interactive item associated with the current user to the second user. As an example, the electronic device 110 may invoke the server 130 to add a predetermined interactive item (e.g., a voting option in the voting component) associated with the current user in the voting component associated with the second user. In this manner, the probability that the current user appears in the voting options of the second user may be increased, and the interaction efficiency and the interaction interestingness of the current user and the second user are further improved.

In some embodiments, the predetermined condition associated with the second user may include, for example, a degree of relationship between the current user and the first user (e.g., a friend relationship, an interaction frequency, etc.) and/or a predetermined event associated with the interactive component (e.g., an operation that needs to be performed by the current user, for example, an interaction operation).

In some embodiments, as shown in FIG. 3F, the electronic device 110 may present, in the session interface 300F of the current user and the target user, a message determined based on the second predetermined operation. As an example, the electronic device 110 may also present an animation effect (e.g., an animation effect associated with the second indication element 225) corresponding to the message in the session interface 300F.

Based on the process described above, embodiments of the present disclosure may utilize the interactive component at the target interface to present content associated with other users for the user. In addition, embodiments of the present disclosure may support the user to quickly send or reply to message content based on a variety of operations including sliding operations. Moreover, in an embodiment of the present disclosure, an indication element for guiding a sliding operation may be provided, and an animation effect associated with the indication element may be provided. Therefore, the embodiment of the disclosure may improve the efficiency of information interaction between users.

### Example Processes

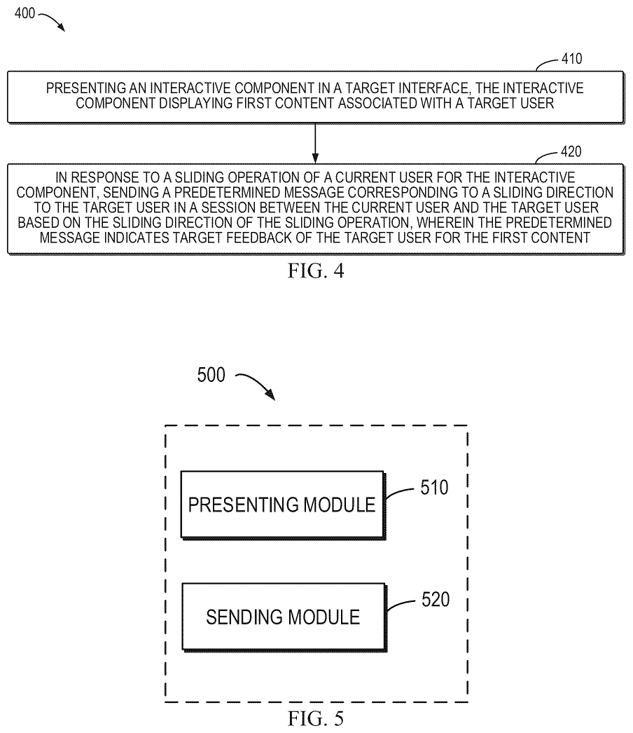

FIG. 4 illustrates a flowchart of an example process 400 of generating media content, according to some embodiments of the present disclosure. Process 400 may be implemented at electronic device 110. The process 400 is described below with reference to FIG. 1.

As shown, at block 410, the electronic device 110 presents an interactive component in a target interface that displays first content associated with a target user.

In block 420, the electronic device 110 sends a predetermined message corresponding to a sliding direction to the target user in a session between a current user and the target user based on a sliding direction of the sliding operation in response to the sliding operation of the current user for the interactive component, where the predetermined message indicates target feedback of the target user for the first content.

In some embodiments, the process 400 further includes: presenting a plurality of indication elements in the target interface, the plurality of indication elements corresponding to a plurality of pieces of predetermined feedback for the first content.

In some embodiments, the process 400 further includes: in response to the sliding operation of the current user for the interactive component, presenting, in the target interface, a first animation associated with a target indication element of a plurality of indication elements, the target indication element corresponding to the target feedback.

In some embodiments, the process 400 further includes: triggering a client associated with the target user: based on the received predetermined message, to present a second animation associated with the target indication element in a session interface presented by the client.

In some embodiments, the process 400 further includes: adjusting a display style of the target indication element to indicate the target feedback corresponding to the sliding operation.

In some embodiments, the interactive component is associated with a set of content including the first content, where the sliding operation is a first sliding operation, the sliding direction is the first sliding direction, and the process 400 further includes: in response to a completion of the first sliding operation, switching the presentation component to presenting second content in the set of content; or in response to receiving a second sliding operation for the interactive component, switching the presentation component to presenting third content in the set of content, a second sliding direction of the second sliding operation being perpendicular to the first sliding direction.

In some embodiments, presenting the interactive component in the target interface includes: presenting, in the target interface, the interactive component in a target style, the target style being determined based on a number of items of content to be presented in the set of content.

In some embodiments, in response to the number of items of the content to be presented being greater than a target threshold, the target style indicates that multiple component elements in the interactive component are presented in a stack.

In some embodiments, the target interface is a viewing interface of an information stream, and the process 400 further includes switching the target interface to presenting media content in the information stream in response to a predetermined operation received in the target interface.

In some embodiments, the process 400 further includes: providing a message portal in the interactive component; and sending a message obtained via the interactive component to the target user in the session between the current user and the target user.

In some embodiments, the first content indicates a selection of a target interaction item associated with the current user by the target user.

### Example Apparatus and Apparatus

Embodiments of the present disclosure also provide a corresponding apparatus for implementing the above method or process. FIG. 5 shows a schematic structural block diagram of an example apparatus 500 for generating media content according to some embodiments of the present disclosure. The apparatus 500 may be implemented or included in an electronic device. The various modules/components in the apparatus 500 may be implemented by hardware, software, firmware, or any combination thereof.

As shown in FIG. 5, the apparatus 500 includes a presenting module 510 configured to present an interactive component in a target interface, the interactive component displaying first content associated with a target user; and a sending module 520 configured to, in response to a sliding operation of a current user with respect to the interactive component, send a predetermined message corresponding to a sliding direction to the target user in a session between the current user and the target user based on the sliding direction of the sliding operation, the predetermined message indicating target feedback of the target user for the first content.

In some embodiments, the apparatus 500 further includes an indication module configured to: present a plurality of indication elements in the target interface, the plurality of indication elements corresponding to a plurality of pieces of predetermined feedback for the first content.

In some embodiments, the apparatus 500 further includes a first animation module configured to: in response to the sliding operation of the current user for the interactive component, present, in the target interface, a first animation associated with a target indication element of the plurality of indication elements, the target indication element corresponding to the target feedback.

In some embodiments, the apparatus 500 further includes a second animation module configured to: trigger a client associated with the target user: based on the received predetermined message, to present, in a session interface presented by the client, a second animation associated with the target indication element.

In some embodiments, the apparatus 500 further includes an adjustment module configured to adjust a display style of the target indication element to indicate the target feedback corresponding to the sliding operation.

In some embodiments, the interactive component is associated with a set of content including the first content, where the sliding operation is a first sliding operation, the sliding direction is a first sliding direction, the apparatus 500 further includes a switching module, and the switching module is configured to: in response to a completion of the first sliding operation, switch the presentation component to presenting second content in the set of content; or in response to receiving a second sliding operation for the interactive component, switch the presentation component to presenting third content in the set of content, where a second sliding direction of the second sliding operation is perpendicular to the first sliding direction.

In some embodiments, the presentation module 510 is further configured to present, in the target interface, an interactive component in a target style, the target style being determined based on a number of items of content to be presented in the set of content.

In some embodiments, in response to the number of items of the content to be presented being greater than a target threshold, the target style indicates that multiple component elements in the interactive component are presented in a stack.

In some embodiments, the target interface is a viewing interface of an information stream, the apparatus 500 further includes a media content module, and the media content module is configured to: in response to a predetermined operation received in the target interface, switch the target interface to presenting media content in the information stream.

In some embodiments, the apparatus 500 further includes a message module configured to: provide a message portal in the interactive component; and send a message obtained via the interactive component to the target user in the session between the current user and the target user.

In some embodiments, the first content indicates a selection of a target interaction item associated with the current user by the target user.

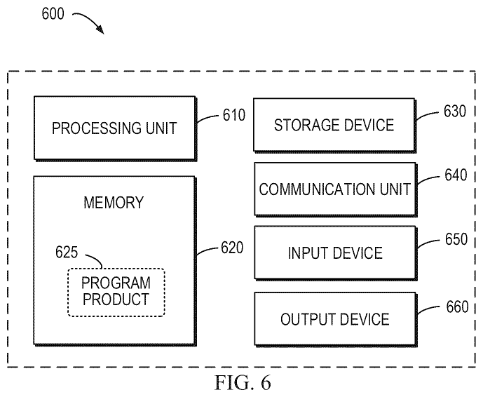

FIG. 6 illustrates a block diagram of an electronic device 600 in which one or more embodiments of the present disclosure may be implemented. It should be understood that the electronic device 600 illustrated in FIG. 6 is merely as an example and should not constitute any limitation on the functionality and scope of the embodiments described herein. The electronic device 600 shown in FIG. 6 may be used in an electronic device.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented according to the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for interface interaction, comprising:
presenting an interactive component in a target interface, the interactive component displaying first content associated with a target user; and
in response to a sliding operation of a current user for the interactive component, sending a predetermined message corresponding to a sliding direction to the target user in a session between the current user and the target user based on the sliding direction of the sliding operation, wherein the predetermined message indicates target feedback of the target user for the first content.

2. The method of claim 1, further comprising:
presenting a plurality of indication elements in the target interface, the plurality of indication elements corresponding to a plurality of pieces of predetermined feedback for the first content.

3. The method of claim 2, further comprising:
presenting, in the target interface, a first animation associated with a target indication element of the plurality of indication elements in response to the sliding operation of the current user for the interactive component, the target indication element corresponding to the target feedback.

4. The method of claim 3, further comprising:
triggering a client associated with the target user: based on the received predetermined message, to present a second animation associated with the target indication element in a session interface presented by the client.

5. The method of claim 3, further comprising:
adjusting a display style of the target indication element to indicate the target feedback corresponding to the sliding operation.

6. The method of claim 1, wherein the interactive component is associated with a set of content comprising the first content, wherein the sliding operation is a first sliding operation, the sliding direction is a first sliding direction, and the method further comprises:
switching the presentation component to presenting second content in the set of content in response to a completion of the first sliding operation; or
switching the presentation component to presenting third content in the set of content in response to receiving a second sliding operation for the interactive component, a second sliding direction of the second sliding operation being perpendicular to the first sliding direction.

7. The method of claim 6, wherein presenting the interactive component in the target interface comprises:
presenting, in the target interface, the interactive component in a target style, the target style being determined based on a number of items of content to be presented in the set of content.

8. The method of claim 7, wherein the target style indicates that multiple component elements in the interactive component are presented in a stack in response to the number of items of the content to be presented being greater than a target threshold.

9. The method according to claim 1, wherein the target interface is a viewing interface of an information stream, and the method further comprises:
switching the target interface to presenting media content in the information stream in response to a predetermined operation received in the target interface.

10. The method of claim 1, further comprising:
providing a message portal in the interactive component; and
sending a message obtained via the interactive component to the target user in the session between the current user and the target user.

11. The method of claim 1, wherein the first content indicates a selection of a target interaction item associated with the current user by the target user.

12. An electronic device, comprising:
at least one processing unit; and
at least one memory coupled to the at least one processing unit and storing instructions for execution by the at least one processing unit, the instructions, when executed by the at least one processing unit, causing the electronic device to:
present an interactive component in a target interface, the interactive component displaying first content associated with a target user; and
in response to a sliding operation of a current user for the interactive component, send a predetermined message corresponding to a sliding direction to the target user in a session between the current user and the target user based on the sliding direction of the sliding operation, wherein the predetermined message indicates target feedback of the target user for the first content.

13. The electronic device of claim 12, wherein the electronic device is further caused to:
present a plurality of indication elements in the target interface, the plurality of indication elements corresponding to a plurality of pieces of predetermined feedback for the first content.

14. The electronic device of claim 13, wherein the electronic device is further caused to:
present, in the target interface, a first animation associated with a target indication element of the plurality of indication elements in response to the sliding operation of the current user for the interactive component, the target indication element corresponding to the target feedback.

15. The electronic device of claim 14, wherein the electronic device is further caused to:
trigger a client associated with the target user: based on the received predetermined message, to present a second animation associated with the target indication element in a session interface presented by the client.

16. The electronic device of claim 14, wherein the electronic device is further caused to:
adjust a display style of the target indication element to indicate the target feedback corresponding to the sliding operation.

17. The electronic device of claim 12, wherein the interactive component is associated with a set of content comprising the first content, wherein the sliding operation is a first sliding operation, the sliding direction is a first sliding direction, and the electronic device is further caused to:
switch the presentation component to presenting second content in the set of content in response to a completion of the first sliding operation; or
switch the presentation component to presenting third content in the set of content in response to receiving a second sliding operation for the interactive component, a second sliding direction of the second sliding operation being perpendicular to the first sliding direction.

18. The electronic device of claim 17, wherein the electronic device is further caused to:
present, in the target interface, the interactive component in a target style, the target style being determined based on a number of items of content to be presented in the set of content.

19. The electronic device of claim 18, wherein the target style indicates that multiple component elements in the interactive component are presented in a stack in response to the number of items of the content to be presented being greater than a target threshold.

20. A non-transitory computer-readable storage medium having stored thereon a computer program executable by a processor to implement a method, comprising:
presenting an interactive component in a target interface, the interactive component displaying first content associated with a target user; and
in response to a sliding operation of a current user for the interactive component, sending a predetermined message corresponding to a sliding direction to the target user in a session between the current user and the target user based on the sliding direction of the sliding operation, wherein the predetermined message indicates target feedback of the target user for the first content.
